(19) United States
(12) Patent Application Publication
(10) Pub. No.: US 2010/0235636 A1
(43) Pub. Date: Sep. 16, 2010

(54) Method for delivering web content and applications to the user via email or other communication channels

(75) Inventor: Ram Cohen, Tel Aviv (IL)

Correspondence Address: ROBERT G. LEV, 4766 MICHIGAN BLVD., YOUNGSTOWN, OH, 44505, US

(73) Assignee: PostalGuard Ltd., Petah Tikva (IL)

(21) Appl. No.: 12/661,203

(22) Filed: Mar. 11, 2010

Related U.S. Application Data
(60) Provisional application No. 61/159,465, filed on Mar. 12, 2009.

(51) Int. Cl. G06F 15/16; G06F 9/445; H04L 9/32; H04L 9/00

(52) U.S. Cl. 713/168; 709/206; 717/174; 709/247; 713/150

(57) ABSTRACT

A method of enabling enriched content of an electronic message including embedding instructions within the electronic message for rendering the content of the message correctly on a recipient system. That may be protected by a firewall, anti virus or anti-spam program, the method comprising the steps of transforming the message content including the embedded instructions into data, in accordance with an algorithm; transmitting the data to the recipient system; receiving the data by recipient system, inverse transforming the data to regenerate the message and the embedded instructions, and executing the embedded instructions to correctly display the enriched content.

### PRIORITY INFORMATION

This application claims benefit of U.S. Provisional Application No. 61/159,465 filed on Mar. 12, 2009, making reference to same herein in its entirety.

### FIELD OF THE INVENTION

The present invention is directed to a method, a system and a computer program product for bypassing web mail HTML filtering, and particularly but not exclusively to safely downloading and rendering enriched electronic messages that includes HTML content that is typically filtered out by webmail programs and by spam filters.

### BACKGROUND

Electronic messaging, such as emails, web based messaging services and SMS are widely used for communicating information between senders and recipients. In the early days of the internet, email messages were simply text. Nowadays, however, email messages are typically written in Hyper Text Markup Language (HTML.

HTML, which stands for Hypertext Markup Language, is the predominant markup language for web pages. It provides a means to create structured documents by denoting structural semantics for text such as headings, paragraphs, lists etc as well as for links, quotes, and other items. It allows images and objects to be embedded and can be used to create interactive forms. It is written in the form of HTML elements consisting of “tags” surrounded by angle brackets within the web page content. It can include or can load scripts in languages such as JavaScript which affect the behavior of HTML processors such as Web browsers, and uses Cascading Style Sheets (CSS) to define the appearance and layout of text and other material. The W3C, which maintains both HTML and CSS standards, encourages the use of CSS over explicit presentational markup.

Email messages written in HTML may be nicely formatted and will adjust themselves to the limitations of the recipient's system, and may include graphic elements, complex fonts, interactive features and embedded objects (such as Adobe Flash) elements. Such elements make content more pleasant to read, provide product differentiation and branding to newsletters and enables interaction of the user with the content.

Most graphical e-mail clients allow the use of a subset of HTML (often ill-defined) to provide formatting and semantic markup not available with plain text. This may include typographic information like colored headings, emphasized and quoted text, inline images and diagrams. Many such clients include both a GUI editor for composing HTML e-mail messages and a rendering engine for displaying them. However, use of HTML in e-mail is controversial because of compatibility issues, and because it can help disguise phishing attacks and may confuse spam filters. Furthermore, the message size is larger than plain text and uses significant bandwidth. Because of the plethora of spam mail and viruses, most users run anti-spam software and firewalls to protect their systems. Additionally, service providers, including both Internet service providers and web mail providers, perform content scanning on the mail traffic to filter out potentially dangerous content such as scripts and embedded objects. These prevent executable code from being transmitted in an email or as an attachment thereto. Such software and firewalls may classify electronic messages as being spam and delete them completely. Less drastically, the electronic message may be ‘cleaned up’, and have embedded images and executable scripts removed.

As HTML mail is more complex than plain text, it is more prone to compatibility issues and has problems with rendering consistently across platforms and software. Some popular clients do not render consistently with W3C specifications, and many HTML e-mails are not compliant, either, which may cause rendering or delivery problems, especially for users of internet based mail programs such as Gmail, MSN and Hotmail.

In particular, the <head> tag, which is used to house CSS style rules for an entire HTML document, is not well supported, and may be stripped entirely, causing in-line style declarations to be the de facto standard, even though they are not optimal from a semantic web point of view. Although workarounds have been developed, this causes frustration among newsletter developers and has resulted in the grassroots Email Standards Project, which grades email clients on their rendering of text, and lobbies developers to improve their products.

The problem of correct email display is particularly acute in web-mail environments, some of which do not allow file attachments. The default e-mail format according to RFC 5322 is plain text. Thus e-mail software is not required to support HTML formatting. Sending HTML formatted e-mails may lead to problems at the recipient's client if it does not support HTML. The recipient may see the HTML source code or nothing at all.

Many providers deliberately block HTML e-mail, either stripping out the HTML part to leave the plain text part only, and some even reject the entire message.

There are additional problems with HTML type emails. An HTML email may allow for a link to have a different target than the link's text. This can be used in phishing attacks, in which users are fooled into believing that a link points to the website of an authoritative source such as a bank, which the user may visit and unintentionally reveal personal details such as bank account numbers and passwords to a scammer.

If an e-mail contains web bugs, such as a URL to an external image that contains a unique identifier, the server can alert a third party that the e-mail has been opened. This is a potential privacy risk, revealing that an e-mail address is real so that it can be targeted in the future, and revealing when the message was read. For this reason, some e-mail clients do not load external images until requested to do so by the user.

Such problems are serious and are taken seriously. For example, during periods of increased network threats, the US Department of Defense converts all incoming HTML e-mail to text email.

Nevertheless, it will be appreciated that the inability to send executable code severely limits the attractiveness of emailed content, such as newsletters, journals and the like. The uncertainty of what will be displayed by the end user is problematic.

One element that is typically filtered out by e-mail clients is the ‘Form’ element. This element provides a means for the user to supply data in appropriate fields (textual, selection and the like) and to send the form data to a server. Although the Form element is central to providing user related content and for performing operations by the user, many currently available mail clients and web mail solutions either strip the ‘Form’ element completely or render it useless by disabling the ability to send data to the server thereby.

One technique widely used for overcoming display limitations of emails is to embed a link from the email to a website where the contents can be viewed properly. One disadvantage of such solutions is that they require interaction by the user. A further disadvantage is that the link may be cleaned by overly zealous anti-spam software and firewalls, making correct displaying impossible.

There is a need to send emails that include rich, formatted content that can be rendered by the recipient system and the present invention addresses this need.

### SUMMARY OF THE INVENTION

In a first aspect, the present invention is directed to providing a method for enabling enriched content of an electronic message comprising embedding instructions to be rendered correctly on a recipient system, comprising the steps of:
(b) transforming the message including the embedded instructions into data, in accordance with an algorithm;
(c) transmitting the data to the recipient system;
(d) receiving the data by the recipient system,
(g) inverse transforming the data to restore the message and to access the embedded instructions, and
(h) the recipient system executing the embedded instructions to correctly render the regenerated message.

Optionally, the instructions comprise an HTML link to a website.

Typically, the message comprises content and enrichment selected from the group consisting of display elements, scripts, objects and forms.

Preferably, recipient system is protected by at least one of the group consisting of firewalls and anti-spam programs, and said transforming/reverse transforming, enables rendering both the content and the enrichment of the message.

In some embodiments the method comprises the preliminary step (a) of: installing a recipient application accessible by the recipient's system for
(i) inverse transforming received message data, and
(ii) recognizing and executing the embedded instructions.

Typically the transformation (b) comprises at least one of the group consisting of encrypting, encoding and compressing.

Optionally, the transformation (b) includes the step of digitally signing at least part of the message or hashing at least part of the message and storing the hash value on a server.

Optionally, the method comprises an intermediate step (d) of prompting recipient to supply a password or decryption key to effect the transformation.

Additionally or alternatively, the method comprises an intermediate step (e) of validating the received data.

Typically, the step of validating comprises at least one of the group consisting of checking internal integrity of the data, checking a digital signature of at least part of the message, checking a hash of at least part of the message against a hash stored at a remote location, and checking for a specific URL

Optionally, the validating is performed by the recipient system.

Optionally, the validating comprises accessing further data at a remote location.

Optionally, the validating requires active authorization by a recipient interaction.

Optionally, the step (h) of correctly rendering the enriched content comprises selectively updating content of the electronic message by executing the embedded instructions.

Alternatively, the step (h) of correctly rendering the enriched content comprises selectively updating content of the electronic message with supplementary data obtained from a server, wherein the supplementary data is dependent on the embedded instructions.

Typically, the transformation is performed by a sender application selected from the list of internet browsers, email program, plug ins/add on programs that add functionality to an application, a stand alone application, applets for browsers, a proxy server and a gateway to senders's organization

In a second embodiment, the present invention is directed to providing a recipient application accessible by a recipient system for inverse transforming a transformed electronic message received from a sender; the transformed electronic message comprising embedded instructions, the recipient application for recognizing and executing the embedded instructions to render the message.

Typically, the recipient application is selected from the group consisting of internet browsers, email program, plug ins/add on programs that add functionality to an application, a stand alone application, applets for browsers, a proxy server and a gateway to recipient's organization.

A third aspect of the invention is directed to providing a sender program for enabling enriched content of an electronic message to be rendered correctly by a recipient system; the sender program for: embedding instructions within the electronic message, and transforming the electronic message including the embedded instructions into data, in accordance with an algorithm known to an application and accessible to the recipient system, for subsequent transmission to the recipient.

Optionally, the transforming comprises at least one of the group consisting of encrypting, encoding and compressing.

A fourth aspect of the invention is directed to providing executable instructions for use with the method described hereinabove.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1 is a functional block diagram showing the essential elements of a messaging program for providing, from trusted senders, electronic messages with enhanced content that may be displayed by a recipient, the electronic message being relatively sturdy to content filtering, firewalls and anti-spam programs;

FIG. 2 is a flowchart illustrating the method of transmitting and accessing enhanced content for correct rendering by the recipient system;

FIG. 3 is an example of embedded instructions for embedding in an email or other electronic message for facilitating enhanced content rendering, and

FIG. 4 is an example of embedded code for embedding in an email or other electronic message, preferably such that it is not displayed to the user on the screen.

### DESCRIPTION OF THE EMBODIMENTS

Aspects of the present invention enables electronic messages such as emails, SMS, gmail, facebook generated messages and the like, to be correctly rendered by recipient systems. Rendering in this instance, relates to the correct display of messages including interactive elements, scripts and forms.

For the sake of clarity, the following description relates to emails. It will, however, be appreciated that the invention is not restricted to emails and is applicable with other electronic messages including Facebook® messages, instant messaging, Twitter® ‘tweets’, web mail providers such as Gmail, SMS and the like.

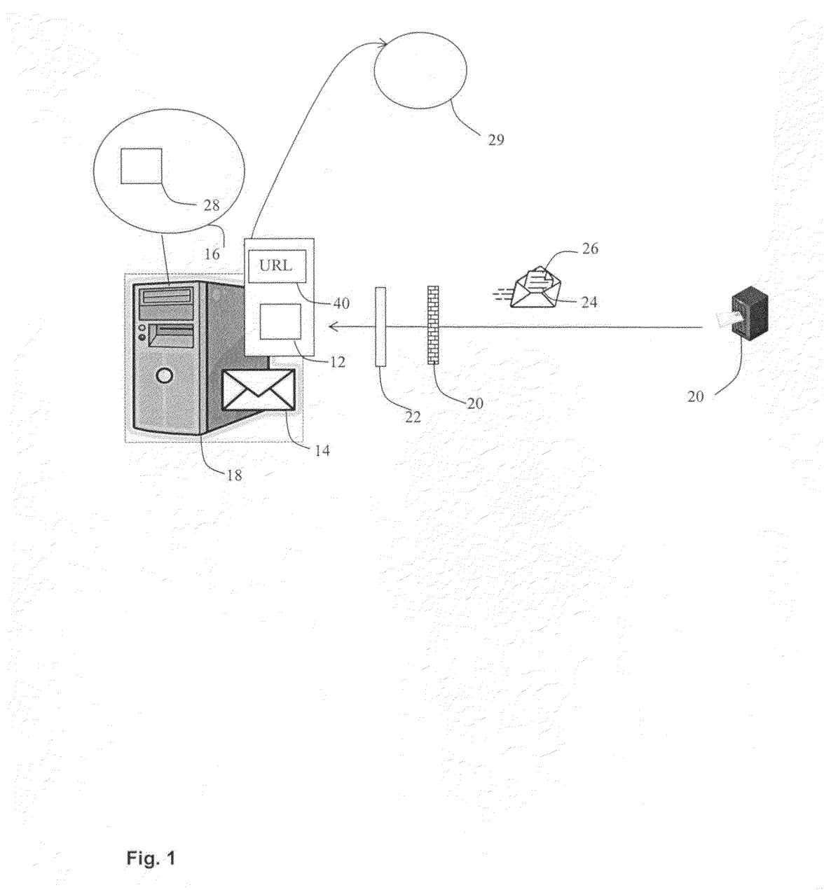

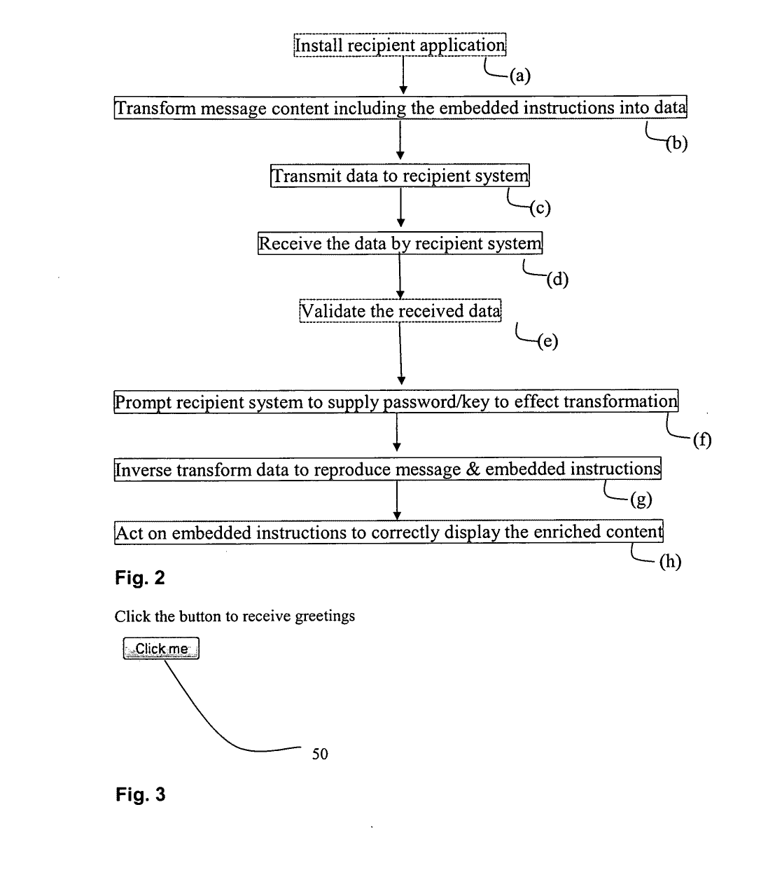

With reference to FIGS. 1 and 2, a method for enabling enriched content 12 of a message such as an email 14, that includes embedded instructions for enriching the content, such as HTML code or a link to a website in HTML, to be displayed correctly by application web browser 16 or email program on a recipient terminal 18 that may be protected by a filtering mechanism such as a firewall 20, anti-spam program 22, or the like, is shown. The method typically comprises a preliminary step (a) of installing a plug in 28 to the browser 16 that is accessible to the recipient system 18 for

(1) inverse transforming (step g) received data 26, and

(2) recognizing and acting (step h) on the embedded instructions 24.

The method, comprises transforming (step b) the electronic message including the embedded instructions 24 into transformed content, i.e. data 26, essentially alphanumeric text. The transforming may include encrypting, encoding or compressing. Then the data 26 is transmitted (step c) to the recipient terminal 18 for review by the recipient, where the data 26 is received (step d) by the recipient terminal 18.

Various subtleties may be included. For example, the recipient may be prompted (step f) to supply a password or decryption key to effect the transformation. Furthermore, the received data may be validated (step e) by checking the internal integrity of the embedded instructions 24, or by checking a digital signature of the message 14, or the received data 26. An additional or alternative validation procedure might be to check for a specific URL. The validating (step e) may be performed on the recipient terminal 18, or by accessing information at a remote location 29 via a URL embedded in the message 14. In some embodiments, the validating (step e) requires active authorization by a recipient interaction, such as with reference to FIG. 3, by selecting and interacting (e.g. clicking) a button.

The data 26 is then inverse transformed (step g) to regenerate the content of the message and to access the embedded instructions 24. The embedded instructions 24 are then acted upon (step h) to correctly render the message, by displaying interactive fields, presenting interactive forms and other enriched content that is typically removed by firewalls 20 and other filters. One way in which this enriched content may be accessed to render the message is by selectively updating the downloaded message with content of the embedded instructions 24 and the rendering.

The inverse transforming (step g) may be performed following by a module configured for so doing. The module may be any of the following non-exhaustive list: internet browsers, email program, plug-ins/add on programs that add functionality to an application, stand alone application, applets for browsers, a proxy server and a gateway to recipient's organization

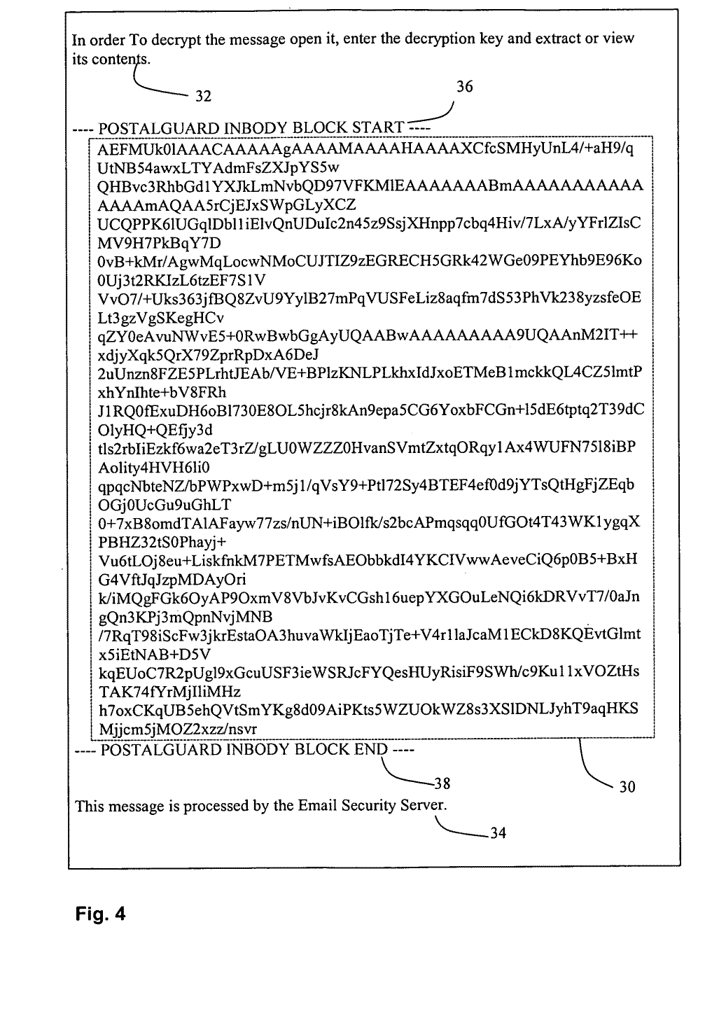

With reference to FIG. 4, content enriching instruction code 30 of the embodiment—which may include executable instructions—is shown. Such code 30 is typically tagged onto the bottom of an email or other electronic message 34. The code 30 may be positioned ‘off screen’ so that recipients without access to a properly configured recipient application such as a browser 16 with plug-in 28 will not be disturbed by the code 30, albeit by virtue of not having access, will not be able to use the code 30 to enhance the rendering of the message displayed. Notably, because the enhanced content is encoded or encrypted, the embedded executable instruction code 30 or executable HTML link usually passes filters 22 and firewalls 20.

The content enriching instruction code 30 is usually tagged at its beginning and end with a START tag 36 and a STOP tag 38 such as BEGIN CONCEALED BLOCK and END CONCEALED BLOCK. The recipient browser plug-in 28 looks for these tags 36, 38 and uses them to locate the embedded executable code. Where the whole message is transformed prior to sending, after reverse transforming (step g) by decoding, decrypting and/or decompressing, the recipient browser 16 plug-in 28 accesses the executable instructions 32 and after executing (step h) the instructions 32, the enhanced content is displayed on the recipient system 18.

In another embodiment, where only the instructions 30 (.e.g. HTML link) is transformed, the process is done slightly differently, as follows:
1. A message is sent from the sender system to a proxy server.
2. The proxy server takes the HTML part of the message, encrypts it with a recipient specific key and encodes the encrypted content as alphanumeric text (e.g. 30—FIG. 4). Optionally, the message as a whole or the HTML part thereof is also digitally signed and the signature data and certificate are also placed in the alphanumeric text.
3. If the message includes attachments, the attachment contents may either be included in the alphanumeric block or placed on a server with a unique URL for each attachment that is itself included in the instruction part of the message, i.e. the part that is transformed.
4. The alphanumeric text is prefixed with a fixed string such as ‘—POSTALGUARD INBODY BLOCK START—’ 36 and suffixed with another fixed string ‘—POSTALGUARD INBODY BLOCK END—’ 38.
5. Additional text 32 with general instructions, notifications etc. may then be added to the start of the message 34 The transformed message (FIG. 4) then replaces the original text of the message and attachments are removed. Since the transformed message is in plain text, it can be put in the plain text section of the message, thereby completely removing the HTML text part from the message to be sent.

The resulting message text looks somewhat as shown in FIG. 4.

For this type of embodiment, on the recipient system 18:
1. A plug in 28 for the browser 16 is installed
2. When a web page is loaded in the browser, the plug in looks for the special prefix 36 and suffix strings 38.
3. When the strings 36, 38 are found, the plug in extracts the text 30 between those strings 36, 38
4. The plug in validates the text block 30 and decodes it
5. The plug in then asks the user for a password
6. The plug in validates the password and if OK, decrypts the decoded block
7. The plug in manipulates the web page in which the strings 36, 38 and text 30 was found to

(i) remove at least the entire block 30 and the markers 36, 38

(ii) place an ‘IFRAME’ element

(iii) loads the decrypted contend into the IFRAME element.

It will be appreciated that alternatively to (ii) and (iii), the plug-in can insert the decrypted content directly to the HTML page where the block 30 was found.
8. If the message contained attachments, the user can click on a URL in the decrypted IFRAME contents to view/download the attachment.

In this manner, emails with enhanced display features, which may include forms, scripts and other interactive content, may be displayed to on the recipient system 18 and fully rendered to the recipient, without jeopardizing security.

It will be appreciated that in the various embodiments, optional safety features may be included. For example, the recipient may be required to verify him/herself using a password; the system prompting (step f) the recipient to do so, or a private key may require to be accessed; the data transmitted may be validated (step e) by being checked for internal consistency and digital signature or hash functions may be used to protect the message as a whole or a portion thereof.

An aspect of the invention is directed to providing a sender end solution 2 for transforming (step b) content 12 including executable content 24 into a format for correct transmission (step c) to a recipient system 18 that may be protected by filters such as a firewall 20 or anti-spam program 22, enabling the enriched content of the email 12 to be displayed correctly on the recipient system 18 after inverse transformation (step g) by the recipient browser or application 28.

The sender system 2 embeds instructions 24 within the message 14, and transforms (step b) the message 14 including the embedded instructions 24 into data 26, essentially alphanumeric text, thereby transforming and essentially neutralizing or concealing the executable programming commands and other features that trip content filtering mechanisms such as firewalls 20 and anti-spam software 22. Typically, the transforming (step b) includes at least one of encrypting, encoding or compressing for subsequent transmitting (step c) to the recipient system 18 for accessing by reverse transformation (step g) in accordance with an algorithm by a recipient application 16 and for executing (step h) the executable content 24 for correct rendering/display. The application 16 may be configured as any of the list of internet browsers, email program, plug ins/add on programs, stand alone application, applets for browsers, proxy servers and the like. It will be appreciated that for providing a solution for an organization, the inverse transformation (step g) may be performed at a gateway rather than by the recipient's terminal.

The application 28 is accessible by a recipient's system 18 for inverse transforming (step g) a transformed content received (step d) as data 26 from a sender 2. the transformed message data 26 when inverse transformed (step g) reproduces embedded instructions 24, which are recognized by the application 28 which acts on, i.e. executes (step h) the embedded instructions 24 or instructs the application 16 to do so.

The recipient application 28 may be configured in a number of ways, including the following non-exhaustive list: internet browsers, email program, plug in/add on programs, stand alone application, applets for browsers, proxy servers and a gateway to recipient's organization.

Notably, since correct display of the HTML enriched content of the email 14 requires the recipient application 28 to conduct a reverse transformation (step g), the recipient system has to have been previously configured to do so, and consequently there is an element of consent that limits susceptibility to both scammers and to viruses.

Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

I claim:

1. A method for enabling enriched content of an electronic message including embedding instructions within the electronic message for rendering the content of the message correctly on a recipient system, comprising the steps of:
(b) transforming the message including the embedded instructions into data, in accordance with an algorithm;
(c) transmitting the data to the recipient;
(d) receiving the data by the recipient system,
(g) inverse transforming the data to regenerate the message and to access the embedded instructions, and
(h) the recipient system executing the embedded instructions to correctly render the regenerated message.

2. The method of claim 1 wherein the message comprises content and enrichment selected from the group consisting of display elements, objects, scripts, executable instructions, and forms.

3. The method of claim 2 wherein despite messages sent to said recipient being filtered, said transforming/reverse transforming, enables rendering both the content and the enrichment of the email.

4. The method of claim 1 comprising the preliminary step of:
(a) installing a recipient application accessible by the recipient's system for inverse transforming received message data, and recognizing and executing the embedded instructions.

5. The method of claim 1, wherein said transforming (b) comprises at least one of the group consisting of encrypting, encoding and compressing.

6. The method of claim 1, comprising an intermediate step (f) of prompting recipient to supply a password or decryption key to effect the transformation.

7. The method of claim 1, comprising an intermediate step (e) of validating the received data.

8. The method of claim 7, wherein said validating comprises at least one of the group consisting of checking internal integrity of the data, checking a digital signature of at least part of the message, checking a hash of at least part of the message against a hash stored at a remote location, and checking for a specific URL

9. The method of claim 8, wherein said validating is performed by the recipient system.

10. The method of claim 8, wherein said validating comprises accessing further data at a remote location.

11. The method of claim 8, wherein said validating requires active authorization by a recipient interaction.

12. The method of claim 1, wherein the step (h) of correctly rendering the enriched content comprises selectively updating content of the electronic message by executing the embedded instructions.

13. The method of claim 1 wherein the step (h) of correctly rendering the enriched content comprises selectively updating content of the electronic message with supplementary data obtained from a server, wherein the supplementary data is dependent on the embedded instructions.

14. The method of claim 1, wherein the transformation is performed by an application selected from the list of internet browsers, email program, plug ins/add on programs that add functionality to an application, a stand alone application, applets for browsers, a proxy server and a gateway server.

15. A recipient application accessible by a recipient's system for inverse transforming a transformed electronic message received from a sender, the transformed electronic message comprising embedded instructions, the recipient application for recognizing and executing the embedded instructions to render the message.

16. The recipient application being selected from the group consisting of internet browsers, email program, plug ins/add on programs that add functionality to an application, a stand alone application, applets for browsers, a proxy server and a gateway to recipient's organization.

17. A sender program for enabling enriched content of an electronic message that includes embedded instructions for correctly rendering the content by a recipient system; the sender program for:
(b) transforming the electronic message including the embedded instructions into data, in accordance with an algorithm known to an application and accessible to the recipient system,
(c) for subsequent transmission to the recipient.

18. The sender program of claim 17, wherein the transforming comprises at least one of the group consisting of encrypting, encoding and compressing.

19. Software for implementing the method of claim 1.
